(19) United States
(12) Patent Application Publication
(10) Pub. No.: US 2012/0131684 A1
(43) Pub. Date: May 24, 2012

(54) AUTOMATIC BACKUP LICENSE TO AVOID SERVICE INTERRUPTIONS IN CONTINUOUS SERVICE, HIGH RELIABILITY SYSTEMS

(76) Inventor: Mark Lynch, Naperville, IL (US)

(21) Appl. No.: 12/950,804

(22) Filed: Nov. 19, 2010

(51) Int. Cl. H04N 7/16

(52) U.S. Cl. 726/29

(57) ABSTRACT

Methods for automatically providing a backup license for a device that relies on a primary license to operate when the primary license for the device fails to satisfy a licensing requirement are provided. A backup license that can become automatically available for use upon noncompliance of a primary license can prevent service interruptions, which are unacceptable for systems that provide continuous service and require high reliability. For example, methods of the disclosure can be used in cable systems and more specifically in cable modem termination systems to prevent an interruption in service.

### TECHNICAL FIELD

This disclosure relates to backup licenses.

### BACKGROUND

A technology vendor may require a customer to agree to certain terms of use contained in a license agreement as a condition for the customer to use its product. For example, if the product is a software application, for example, the equipment vendor may require that the application run only on a particular device to prohibit unauthorized copies of the software application. As another example, for a software application, the equipment vendor may limit how many users may use the software application at the same time.

To ensure that customers comply with the terms of license agreements, equipment vendors may employ license enforcement mechanisms (e.g., authentication, techniques, license managers, etc.) upon installation or during the use of their products. For example, to ensure that a software application runs only on a particular device, during installation or activation of the software application on the device, the equipment vendor may require that the customer enter a unique license key when prompted by the application. The license key can be a unique, equipment-specific, encrypted string of alphanumeric characters provided by the equipment vendor to the customer and can include the device's unique serial number and other information. Once the customer enters a license key, the application determines whether the license key entered by the customer is the valid license key for the device running the application. If the license key entered by the customer is valid, the application can store the license key in memory for future checks. If the license key entered by the customer is invalid, then the application may not be installed or enabled and, therefore, can be unavailable to the customer.

As another example, if a license agreement limits the number of concurrent users of an application, a license server can be used to ensure that the agreed upon use is not exceeded. For example, an application can be made available on a network for use by multiple users. When a user desires to use the application, a license server can issue a license to the user to run the application so long as the number of concurrent users permitted for the application is not exceeded. If the number of concurrent users permitted for the application has been reached, then use of the application by additional users is not permitted.

Thus, license enforcement mechanisms can restrict or limit the use of a product. If a product is used in a system that provides services to subscribers, a license enforcement mechanism can result in service interruptions to the subscribers if use of the product is restricted or limited upon failure to meet a license requirement. However, service interruptions are unacceptable for systems that provide continuous service and require high reliability, such as, for example, a cable system that can deliver high-definition digital entertainment and telecommunications such as video, voice, and high-speed Internet to subscribers.

Accordingly, there is a need for a licensing model that may protect equipment vendors yet ensure uninterrupted service in systems that provide continuous service and require high reliability for noncompliance of a licensing requirement.

### BRIEF DESCRIPTION OF THE DRAWINGS

FIG. 1 illustrates an example process for automatically providing a backup license when a primary license fails to satisfy a license requirement.

FIG. 2 illustrates an example cable system.

FIG. 3 illustrates an example cable access module of the cable system of FIG. 2 operable to perform the example process of FIG. 1.

### DETAILED DESCRIPTION

Various implementations of this disclosure automatically create and use a backup license to avoid service interruptions when a primary license fails to satisfy a licensing requirement.

Devices or systems that rely on licenses to operate can be interrupted if a license enforcement mechanism fails. There can be numerous reasons for such failures. For example, a stored license key may become deleted or corrupted or the user may have exceeded the terms of a license agreement. For devices or systems that provide continuous service, interruption due to license noncompliance is undesirable as these interruptions can reduce quality of service and can eventually lead to a loss of customers.

A backup license that can become automatically available for use upon noncompliance of a primary license can prevent service interruptions. A backup license can specify, for example, how long the license will be valid, what services will be available with the license, and on which device(s) the license will work, among other things. A backup license can have any form and usage rights. For example, the backup license can be a use-once license or can be limited based on time and/or usage. In some implementations, a backup license can have the same form as a primary license but with a limitation on use based on time and/or usage. In some implementations, the backup license provides the same access to the licensed service as the primary license. In some implementations, a backup license can be a timer that counts down based on usage or passage of time.

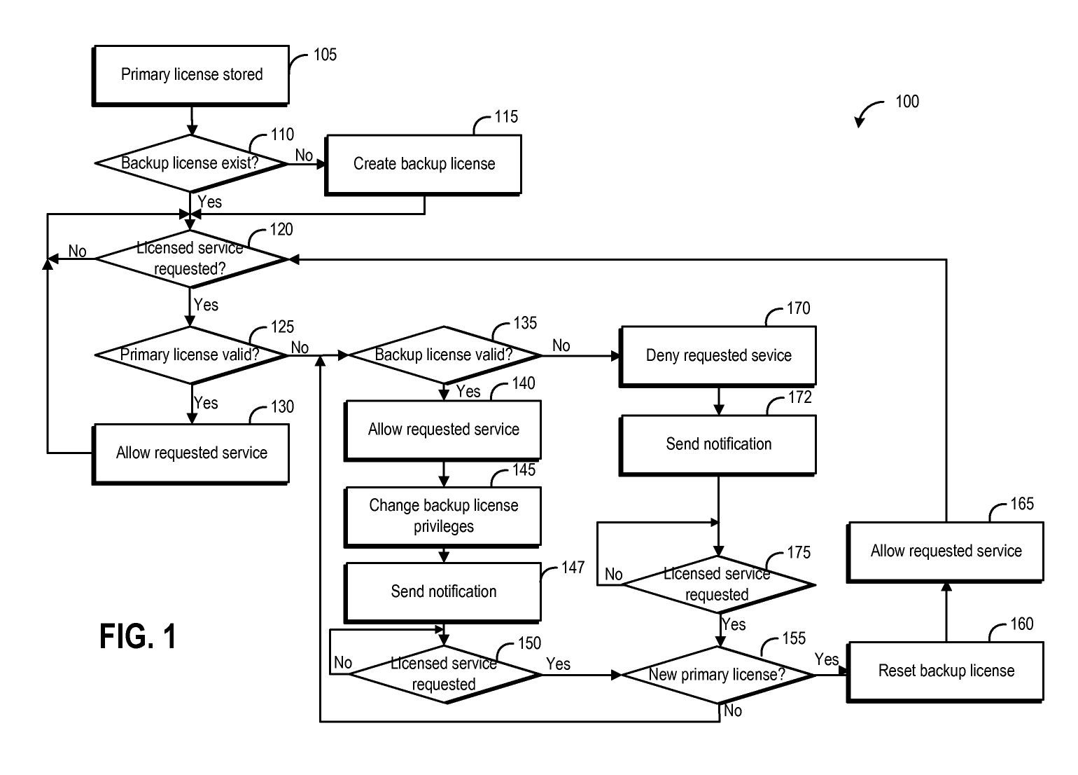

FIG. 1 illustrates an example process 100 for automatically providing a backup license when a primary license fails to satisfy a license requirement. In some implementations, process 100 can be performed by one or more programmable processors or can also be performed by, and apparatus can also be implemented as, special purpose logic circuitry, e.g., an ASIC (application specific integrated circuit). The process 100 can be implemented with any existing or later developed license enforcement mechanism.

At stage 105, a primary license can be stored on a device or system. In some implementations, a primary license is stored in an EEPROM (i.e., Electrically Erasable Programmable Read Only Memory). There are numerous existing methods for creating and storing a license on a device. One of ordinary skill in the art would know how to create and store a license. This disclosure is not limited to any particular method of creating and storing a license. The process 100 can be implemented with any existing or later developed method for creating and storing a license.

At stage 110, it is determined whether a backup license exists. In some implementations a backup license may be stored in EEPROM.

If a backup license exists (i.e., “Yes” at stage 110), then at stage 120, it is determined whether a service (e.g., an application or device functionality) has been requested that requires a license. Until such a request has been made, the process 100 can remain at stage 120. Returning to stage 110, if no backup license exists (i.e., “No” at stage 110), then at stage 115, a backup license is created and the process 100 moves to stage 120. As discussed above, a backup license can have any form. For example, a backup license can have the same form as a primary license. In some implementations, a backup license can be a timer. One of ordinary skill in the art would know how to create a backup license. This disclosure is not limited to any particular form of backup license.

If a request for a licensed service is made (i.e., “Yes” at stage 120), then at stage 125, it is determined whether the primary license is valid. A request for a licensed service can be deemed to have been made by an attempt to use a licensed service. One of ordinary skill in the art would know how to determine whether a primary license is valid. This disclosure is not limited to any particular type of license enforcement mechanism. The process 100 can be implemented with any existing or later developed license enforcement mechanism.

If the primary license is valid (“Yes” at stage 125), then at stage 130, the requested service is made available and the process 100 returns to stage 120 and awaits another request for a licensed service.

If a primary license is not valid or a license enforcement test otherwise fails (“No” at stage 125), then at stage 135, it is determined whether a backup license is valid. In some implementations, it can be determined whether a backup license is valid based on the amount of time remaining for the backup license. One of ordinary skill in the art would know how to determine whether a backup license is valid. This disclosure is not limited to any particular algorithm for determining whether a backup license is valid. The process 100 can be implemented with any existing or later developed algorithm for determining whether a backup license is valid.

If the backup license is valid (“Yes” at stage 135), then at stage 140, the requested service is made available and the process 100 proceeds to stage 145. At stage 145, the backup license privileges can be reduced, depreciated, or otherwise changed. For example, the number of available uses of the backup license can be reduced or the amount of time or available usage remaining before expiration of the backup license can be reduced. In this way, the backup license may not be perpetual.

At stage 147, a notification can be sent to the customer. In some implementations, the notification can inform the customer that the primary license is invalid and/or inform the customer of the amount of privileges (e.g., time, number of uses) remaining for the backup license. In some implementations, a notification can be sent to the equipment vendor.

At stage 150, process 100 waits until another request for a licensed service is made. If a request for a licensed service is made (i.e., “Yes” at stage 150), then at stage 155, it is determined whether a new primary license has been activated. If a new primary license has not been activated (i.e., “No” at stage 155), then the process 100 returns to stage 135 where it is determined whether a backup license is valid. If the backup license is valid (“Yes” at stage 135), then at stage 140, the requested service is made available and the process 100 proceeds to stage 145 where the backup license privileges can be reduced. Thus, in the absence of a valid primary license, so long as the backup license is valid, a requested licensed service can be made available. However, in some implementations, every use of the backup license reduces the backup license privileges (e.g., time remaining) and once the backup license is no longer valid (i.e., “No” at stage 135), then at stage 170, the requested service is denied. At stage 172, a notification can be sent to the customer informing the customer that the backup license is invalid and the requested service has been denied. In some implementations, a notification can be sent to the equipment vendor. Thereafter, a requested licensed service (“Yes” at stage 175) may not be available until a new primary license is activated (“Yes” at stage 155) or there is a valid backup license (“Yes” at stage 135).

Returning to stage 150, once a backup license had been used (i.e., once process 100 has performed stages 135 and 140) and subsequently a licensed service is requested (“Yes” at stage 150), if a new primary license has been activated (“Yes” at stage 155), then at stage 160, the backup license can be reset. In some implementations, the backup license is reset as if originally created at stage 115. In this way, if the new primary license becomes invalid in the future, the backup license can be available to avoid service interruptions. At stage 165, the requested service is made available and the process 100 returns to stage 120 and awaits another request for a licensed service.

As discussed above, service interruptions due to unintentional noncompliance of a primary license are unacceptable for systems that provide continuous service and require high reliability. There are numerous such systems that provide continuous service and require high reliability, such as, for example, a cable system that can deliver high-definition digital entertainment and telecommunications such as video, voice, and high-speed Internet to subscribers.

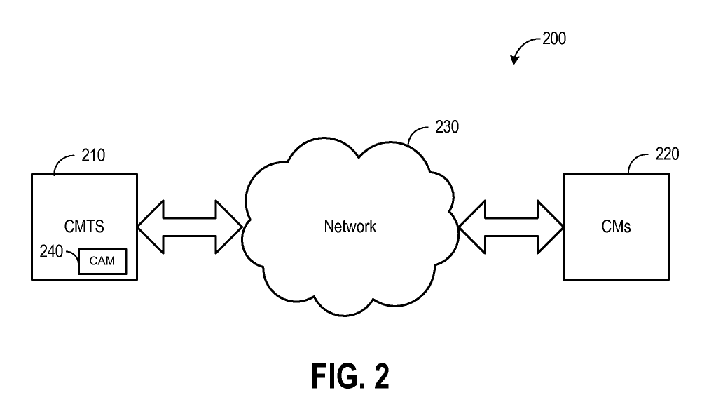

FIG. 2 illustrates an example cable system 200. As show in FIG. 2, traffic (e.g., data, video, and voice signal) is transferred over a cable network 230 between a Cable Modem Termination System (CMTS) 210 and cable modems (CMs) 220. The CMTS 210 is located at a cable system head-end and the CMs 220 are located at subscriber premises. The cable network 230 can take the form of either an all-coax, all-fiber, or hybrid fiber/coax (HFC) network.

Devices within the CMTS 210 such as one or more cable access modules (CAMs) 240 may rely on a license to operate. A CAM provides the cable side interface to CMs. Accordingly, data, video, and voice signals travel through a CAM to reach a subscriber. If a license enforcement mechanism fails within a CAM, then the CAM may become disabled and data, video, and voice services to subscribers may be interrupted. To avoid such result, the CMTS 210 can implement the example process 100 of FIG. 1 to provide a backup license when, for example, a primary license for the CAM 240 fails to satisfy a license requirement.

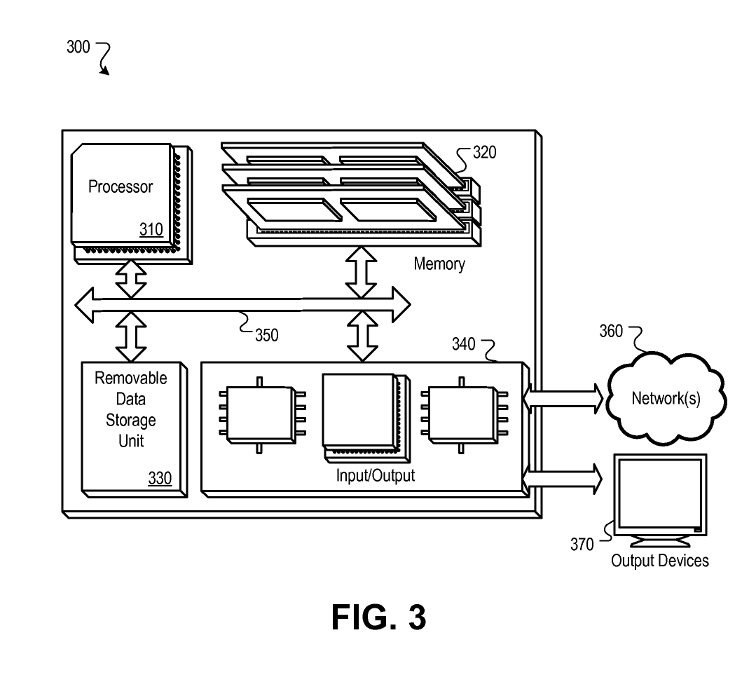

FIG. 3 illustrates an example CAM 300 operable to perform the example process 100 of FIG. 1.

The CAM 300 can include a processor 310, a memory 320, a removable data storage unit 330, and an input/output device 340. Each of the components 310, 320, 330, and 340 can, for example, be interconnected using a system bus 350. The processor 310 is capable of processing instructions for execution within the CAM 300. For example, the processor 310 can be capable of processing instructions for executing the process 100 of FIG. 1 in CAM 300. In some implementations, the processor 310 is a single-threaded processor. In other implementations, the processor 310 is a multi-threaded processor. The processor 310 is capable of processing instructions stored in the memory 320 or on the storage device 330.

The memory 320 stores information within the CAM 300. For example, memory 320 may store the primary license and backup license. In other implementations, the backup license can be stored on another module within the CMTS, so that when a failed CAM 300 is replaced, the replacement CAM (whose memory may not contain the primary license) could still use the backup license and interruption of service can be avoided. In some implementations, the memory 320 is a computer-readable medium. In other implementations, the memory 320 is a volatile memory unit. In still other implementations, the memory 320 is a non-volatile memory unit.

In some implementations, the removable data storage unit 330 is capable of providing mass storage for CAM 300. In some implementations, the storage device 330 is a computer-readable medium. In various different implementations, the storage device 330 can, for example, include a hard disk device, an optical disk device, flash memory or some other large capacity storage device.

The input/output device 340 provides input/output operations for the CAM 300. In some implementations, the input/output device 340 can include one or more of a wireless interface, network interface 360, such as, for example, an IP network interface device, e.g., an Ethernet card, a cellular network interface, an optical interface device, a serial communication device, e.g., an RS-232 port, and/or a wireless interface device, e.g., and 802.11 card. In another implementation, the input/output device can include driver devices configured to receive input data and send output data to other input/output devices (e.g., a monitor 370), as well as sending communications to, and receiving communications from various networks. For example, input/output device 340 can be used to send notifications to customers or other third parties, such as the equipment vendor.

Implementations of the device of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, implementations of the subject matter described in this specification can be operable to interface with a computing device having a display, e.g., a CRT (cathode ray tube) or LCD (liquid crystal display) monitor, for displaying information to the user and a keyboard and a pointing device, e.g., a mouse or a trackball, by which the user can provide input to the computer.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method for automatically providing a backup license for a device that relies on a primary license to operate when the primary license for the device fails to satisfy a licensing requirement, the method comprising:
using a backup license to deliver a licensed service if a primary license for the service fails;
changing the privileges of the backup license after use of the backup license;
sending a notification informing of one or more license statuses; and
resetting the backup license once a primary license is activated.

2. The method of claim 1 further comprising determining whether a backup license exists and creating a backup license if one does not exist.

3. The method of claim 1 further comprising determining whether the backup license is valid prior to using the backup license.

4. The method of claim 1 wherein a notification is sent informing that the primary license has failed.

5. The method of claim 1 wherein the notification is sent informing of the amount of privileges remaining for the backup license.

6. The method of claim 1 wherein the licensed service is provided by a licensed component in a cable modem termination system.

7. The method of claim 6 wherein the backup license is stored on a module of the cable modem termination system other than the licensed component.

8. The method of claim 6 wherein changing the privileges of the backup license after use of the backup license comprises reducing the amount of usage available based on usages of the licensed component.

9. The method of claim 6 wherein the licensed component is a cable access module.

10. A computer readable medium having instructions for causing a computer to execute a method for automatically providing a backup license for a device that relies on a primary license to operate when the primary license for the device fails to satisfy a license requirement, the method comprising:
using a backup license to deliver a licensed service if a primary license for the service fails;
changing the privileges of the backup license after use of the backup license;
sending a notification informing of one or more license statuses; and
resetting the backup license once a primary license is activated.

11. The computer readable medium of claim 10 wherein the method further comprises determining whether a backup license exists and creating a backup license if one does not exist.

12. The computer readable medium of claim 10 wherein the method further comprises determining whether the backup license is valid prior to using the backup license.

13. The computer readable medium of claim 10 wherein a notification is sent informing that the primary license has failed.

14. The computer readable medium of claim 10 wherein a notification is sent informing of the amount of privileges remaining for the backup license.

15. The computer readable medium of claim 10 wherein the licensed service is provided by a licensed component in a cable modem termination system.

16. The computer readable medium of claim 15 wherein the backup license is stored on a module of the cable modem termination system other than the licensed component.

17. The computer readable medium of claim 15 wherein changing the privileges of the backup license after use of the backup license comprises reducing the amount of usage available based on usages of the licensed component.

18. The computer readable medium of claim 15 wherein the licensed component is a cable access module.

19. A system for automatically providing a backup license for a device that relies on a primary license to operate when the primary license for the device fails to satisfy a license requirement, the system comprising:
means for using a backup license to deliver a licensed service if a primary license for the service fails;
means for changing the privileges of the backup license after use of the backup license;
means for sending a notification informing of one or more license statuses; and
means for resetting the backup license once a primary license is activated.

20. A system for automatically providing a backup license for a device that relies on a primary license to operate when the primary license for the device fails to satisfy a license requirement, the system comprising:
a licensed component in a cable modem termination system; and
a storage device for storing a backup license wherein the storage device is in a module of the cable modem termination system other than the licensed component.
